(19) United States
(12) Patent Application Publication
(10) Pub. No.: US 2006/0260155 A1
(43) Pub. Date: Nov. 23, 2006

(54) Device for displaying images sporadically on a mirrored surface

(75) Inventor: Jesus Molleda Leon, Madrid (ES)

Correspondence Address: BIRCH STEWART KOLASCH & BIRCH, PO BOX 747, FALLS CHURCH, VA, 22040-0747, US

(73) Assignee: International Media Publiespejo, S.L., Madrid (ES)

(21) Appl. No.: 11/132,350

(22) Filed: May 19, 2005

(51) Int. Cl. G09F 13/12

(52) U.S. Cl. 40/219; 40/900

(57) ABSTRACT

A display device for advertising messages comprises a mirror of the type known as a see-through mirror, behind which a message to be displayed is placed on a suitable support. A plurality of light fittings are placed behind the message which light up sporadically under the control of an electronic controller, at which time the message becomes visible through the see-through mirror.

Device for displaying images sporadically on a mirrored surface.

The present invention relates to a device that can display a message in a sporadic manner on a mirrored surface.

Its field of application is advertising, as well as signalling of any type, whenever a surprise effect is sought that catches the user's attention towards the message to convey.

The diverse problems currently suffered by advertising are well known. Among them are the following:
The high cost of certain media, such as TV, magazines, radio, etc.
The saturation to which the public is subjected on the street by static advertising
The need to reach a specific consumer more directly, at the best time and place.

Therefore, an object of the present invention is to provide a low-cost device that allows displaying advertising focussed at a specific consumer in a specific location, in an unexpected and surprising way.

The device object of the present invention comprises a mirror of the type known as a see-through mirror, behind which the message is placed on a suitable support. A plurality of light fittings are placed behind the message which light up sporadically under the control of an electronic controller, at which time the message becomes visible through the see-through mirror. In the context of this document, a see-through mirror is defined as a transparent panel with a surface treatment based on metallic compounds that confer the property of making one of its faces act as a mirror, reflecting light, whenever it is not illuminated on the opposite face; at such time, it will lose its reflecting properties and act as a simple stained glass, allowing to see through it. This type of mirror is known and usually used as a peephole in doors, wherein it acts as a conventional mirror in one direction while in the other it allows to see through it. The invention is based on the hitherto unexploited fact that this type of mirror loses its reflective properties if it is illuminated from the rear fact with sufficient intensity.

This allows to issue optical messages of any type, whether advertising, informative, safety, etc.

The advantages of the device object of the invention are the following:
It does not constitute an optical intrusion on the decoration when the light fittings are turned off
It allows a great flexibility for both the message insertion time and the message type, as well as its adaptation to the places best-suited to the target public
It offers a high effectiveness due to its notoriety, as in addition to the fact that nothing similar exists in the market, the surprise effect draws attention to the message.

To complete the description being made and in order to aid a better understanding of the characteristics of the invention, a detailed description is made of a preferred embodiment based on a set of drawings accompanying this descriptive memory, where for purposes of illustration only and in a non-limiting sense the following is shown:

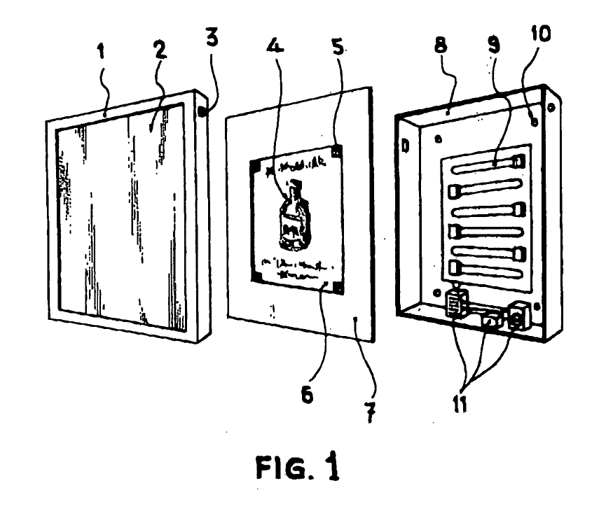

FIG. 1 shows an exploded perspective view of the device object of the invention.

In said figure the numerical references correspond to the following parts and elements:
1. Outer frame
2. See-through mirror
3. Lock
4. Message
5. Attachments
6. Translucent central part of the opaque frame (7)
7. Opaque frame
8. Box
9. Light fittings
10. Screws
11. Electronic controller

As can be seen in FIG. 1, the device object of the invention comprises a box (8) which can be attached to the wall by the screws (10), inside which are placed a plurality of light fittings (9) and an electronic controller (11) fitted in the front part of the box (8) such that it can be immobilised with respect to it by a lock (3) is an outer frame (1), whose central part is occupied by a see-through mirror (2). Between the see-through mirror (2) and the light fittings (9) is placed a message (4) in the form of a slide or transparency, attached to the translucent central part (6) of an opaque frame (7) by attachments (5).

The operation of the device object of the invention is as follows. While the light fittings (9) are turned off, the see-through mirror (2) behaves as a normal mirror, totally reflecting the light and objects placed in front of it, such as for example any onlookers. Sporadically, by the action of the electronic controller (11), the light fittings (9) are activated, revealing the message (4) through the see-through mirror (2) as the latter loses its reflecting properties.

An expert in the field will find obvious a number of alternative industrial embodiments and adaptations to specific purposes that may be executed without straying from the essence of the invention, as claimed in the claims. This, the outer frame (1) can be fitted on the box (8), as described, but could also have the form of a hinged door. The message (4) could be immobilised by various means using any type of suitable attachments (5), such as metal clips, grooves or even adhesive strips, including even the elimination of the opaque frame (7), as the message (4) could be placed directly on the box (8) or the outer frame (1).

1. Device for displaying messages sporadically on a mirrored surface, characterised in that the message (4) is placed between a see-through mirror (2) that constitutes the mirrored surface and a plurality of light fittings (9) that can be turned on by the action of an electronic controller (11); such that when the light fittings (9) are turned off the see-through mirror (2) presents a reflecting surface while when the light fittings (9) are turned on the see-through mirror (2) loses its reflecting properties, revealing the message (4) through it.

2. Device for displaying messages sporadically on a mirrored surface according to claim 1, characterised in that the see-through mirror (2) is placed in an outer frame (1) that can be immobilised by a lock (3) with respect to a box (8) that contains the light fittings (9) and the electronic controller (11).

3. Device for displaying messages sporadically on a mirrored surface according to claim 2, characterised in that the message (4) is placed on the translucent central part (6) of an opaque frame (7) by the attachments (5).

4. Device for displaying messages sporadically on a mirrored surface according to claim 3, characterised in that the attachments (5) are constituted by metallic clips.
